(19) United States
(12) Patent Application Publication
(10) Pub. No.: US 2025/0097986 A1
(43) Pub. Date: Mar. 20, 2025

(54) RADIO NETWORK TEMPORARY IDENTIFIER SELECTION FOR MULTIPLE RANDOM ACCESS TRANSMISSIONS

(71) Applicant: QUALCOMM Incorporated, San Diego, CA (US)

(72) Inventors: Hung Dinh LY, San Diego, CA (US); Kexin XIAO, Shanghai (CN); Hwan Joon KWON, San Diego, CA (US)

(21) Appl. No.: 18/728,373

(22) PCT Filed: Apr. 2, 2022
(86) PCT No.: PCT/CN2022/085016

§ 371 Date: Jul. 11, 2024

(51) Int. Cl. H04W 74/0833; H04W 72/1268

(52) U.S. Cl. CPC H04W 74/0833; H04W 72/1268

(57) ABSTRACT

Methods, systems, and devices for wireless communication at a user equipment (UE) are described. A UE may receive an indication of a set of random access occasions associated with a random access procedure. The UE may transmit a set of uplink random access channel messages over the set of random access occasions corresponding to the set of uplink random access channel messages. The UE may select a radio network temporary identifier for the UE based on a defined position within the set of random access occasions and receive a downlink random access channel message using the radio network temporary identifier based on the defined position within the set of random access occasions.

### CROSS REFERENCE

The present application is a 371 national stage filing of International PCT Application No. PCT/CN2022/085016 by L Y et al. entitled “RADIO NETWORK TEMPORARY IDENTIFIER SELECTION FOR MULTIPLE RANDOM ACCESS TRANSMISSIONS,” filed Apr. 2, 2022, which is assigned to the assignee hereof, and which is expressly incorporated by reference in its entirety herein.

### TECHNICAL FIELD

The following relates to wireless communication at a user equipment (UE), including radio network temporary identifier selection for multiple random access transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). Some techniques for random access transmissions may be enhanced.

### SUMMARY

The described techniques relate to improved methods, systems, devices, and apparatuses that support radio network temporary identifier selection for multiple random access transmissions. For example, the described techniques provide for techniques for selecting a radio network temporary identifier for a communication device based on a defined position within the set of random access occasions. Network coverage of an area may be improved by using multiple random access channel occasions for uplink transmission. A user equipment (UE) may receive an indication of a set of random access occasions associated with a random access procedure and may transmit multiple random access channel messages over the set of random access occasions. According to techniques depicted herein, the UE and a network entity may select a radio network temporary identifier based on a defined position within the set of random access occasions. The UE and the network entity may then use the selected radio network temporary identifier in encoding and decoding communications.

A method for wireless communication at a UE is described. The method may include receiving an indication of a set of multiple random access occasions associated with a random access procedure, transmitting a set of multiple uplink random access channel messages over the set of multiple random access occasions corresponding to the set of multiple uplink random access channel messages, selecting a radio network temporary identifier for the UE based on a defined position within the set of multiple random access occasions, and receiving a downlink random access channel message using the radio network temporary identifier based on the defined position within the set of multiple random access occasions.

An apparatus for wireless communication at a UE is described. The apparatus may include at least one processor, and memory coupled to the at least one processor, the memory storing instructions executable by the at least one processor to cause the UE to receive an indication of a set of multiple random access occasions associated with a random access procedure, transmit a set of multiple uplink random access channel messages over the set of multiple random access occasions corresponding to the set of multiple uplink random access channel messages, select a radio network temporary identifier for the UE based on a defined position within the set of multiple random access occasions, and receive a downlink random access channel message using the radio network temporary identifier based on the defined position within the set of multiple random access occasions.

Another apparatus for wireless communication at a UE is described. The apparatus may include means for receiving an indication of a set of multiple random access occasions associated with a random access procedure, means for transmitting a set of multiple uplink random access channel messages over the set of multiple random access occasions corresponding to the set of multiple uplink random access channel messages, means for selecting a radio network temporary identifier for the UE based on a defined position within the set of multiple random access occasions, and means for receiving a downlink random access channel message using the radio network temporary identifier based on the defined position within the set of multiple random access occasions.

A non-transitory computer-readable medium storing code for wireless communication at a UE is described. The code may include instructions executable by at least one processor to receive an indication of a set of multiple random access occasions associated with a random access procedure, transmit a set of multiple uplink random access channel messages over the set of multiple random access occasions corresponding to the set of multiple uplink random access channel messages, select a radio network temporary identifier for the UE based on a defined position within the set of multiple random access occasions, and receive a downlink random access channel message using the radio network temporary identifier based on the defined position within the set of multiple random access occasions.

In some examples of the method, apparatuses, and non-transitory computer-readable medium described herein, transmitting the set of multiple uplink random access channel messages may include operations, features, means, or instructions for transmitting, on a random access occasion of the set of multiple random access occasions corresponding to the defined position, an uplink random access channel message of the set of multiple uplink random access channel messages, the uplink random access channel message including a random access channel preamble, where the defined position within the set of multiple random access occasions corresponds to a sequentially first position of the random access occasion within the set of multiple random access occasions.

In some examples of the method, apparatuses, and non-transitory computer-readable medium described herein, transmitting the set of multiple uplink random access channel messages may include operations, features, means, or instructions for transmitting, on a random access occasion of the set of multiple random access occasions corresponding to the defined position, an uplink random access channel message of the set of multiple uplink random access channel messages, the uplink random access channel message including a random access channel preamble, where the defined position within the set of multiple random access occasions corresponds to a sequentially last position of the random access occasion within the set of multiple random access occasions.

Some examples of the method, apparatuses, and non-transitory computer-readable medium described herein may further include operations, features, means, or instructions for receiving an index of a random access occasion at the defined position within the set of multiple random access occasions.

Some examples of the method, apparatuses, and non-transitory computer-readable medium described herein may further include operations, features, means, or instructions for transmitting an uplink random access channel message of the set of multiple uplink random access channel messages, where a start of a random access response window may be based on a random access occasion of the set of multiple random access occasions, and where the random access response window may be for receiving the downlink random access channel message upon transmitting the uplink random access channel message of the set of multiple uplink random access channel messages.

Some examples of the method, apparatuses, and non-transitory computer-readable medium described herein may further include operations, features, means, or instructions for identifying that the defined position within the set of multiple random access occasions corresponds to the random access occasion based on determining the start of the random access response window using the random access occasion.

Some examples of the method, apparatuses, and non-transitory computer-readable medium described herein may further include operations, features, means, or instructions for receiving a control portion of the downlink random access channel message, where the control message includes a cyclic redundancy check scrambled by the radio network temporary identifier.

In some examples of the method, apparatuses, and non-transitory computer-readable medium described herein, transmitting the set of multiple uplink random access channel messages may include operations, features, means, or instructions for transmitting, on a first random access occasion of the set of multiple random access occasions corresponding to the defined position, a first uplink random access channel message of the set of multiple uplink random access channel messages and transmitting, on a second random access occasion of the set of multiple random access occasions corresponding to the defined position, a second uplink random access channel message of the set of multiple uplink random access channel messages, where the second uplink random access channel message may be transmitted later than the first uplink random access channel message.

Some examples of the method, apparatuses, and non-transitory computer-readable medium described herein may further include operations, features, means, or instructions for identifying that the defined position within the set of multiple random access occasions corresponds to the second random access occasion based on the second uplink random access channel message being transmitted later than the first uplink random access channel message.

A method for wireless communication at a network entity is described. The method may include transmitting an indication of a set of multiple random access occasions associated with a random access procedure, receiving a set of multiple uplink random access channel messages over a set of multiple random access occasions corresponding to the set of multiple uplink random access channel messages, selecting a radio network temporary identifier for a UE based on a defined position within the set of multiple random access occasions, and transmitting a downlink random access channel message using the radio network temporary identifier based on the defined position within the set of multiple random access occasions.

An apparatus for wireless communication at a network entity is described. The apparatus may include at least one processor, and memory coupled to the at least one processor, the memory storing instructions executable by the at least one processor to cause the network entity to transmit an indication of a set of multiple random access occasions associated with a random access procedure, receive a set of multiple uplink random access channel messages over a set of multiple random access occasions corresponding to the set of multiple uplink random access channel messages, select a radio network temporary identifier for a UE based on a defined position within the set of multiple random access occasions, and transmit a downlink random access channel message using the radio network temporary identifier based on the defined position within the set of multiple random access occasions.

Another apparatus for wireless communication at a network entity is described. The apparatus may include means for transmitting an indication of a set of multiple random access occasions associated with a random access procedure, means for receiving a set of multiple uplink random access channel messages over a set of multiple random access occasions corresponding to the set of multiple uplink random access channel messages, means for selecting a radio network temporary identifier for a UE based on a defined position within the set of multiple random access occasions, and means for transmitting a downlink random access channel message using the radio network temporary identifier based on the defined position within the set of multiple random access occasions.

A non-transitory computer-readable medium storing code for wireless communication at a network entity is described. The code may include instructions executable by at least one processor to transmit an indication of a set of multiple random access occasions associated with a random access procedure, receive a set of multiple uplink random access channel messages over a set of multiple random access occasions corresponding to the set of multiple uplink random access channel messages, select a radio network temporary identifier for a UE based on a defined position within the set of multiple random access occasions, and transmit a downlink random access channel message using the radio network temporary identifier based on the defined position within the set of multiple random access occasions.

In some examples of the method, apparatuses, and non-transitory computer-readable medium described herein, receiving the set of multiple uplink random access channel messages may include operations, features, means, or instructions for receiving, on a random access occasion of the set of multiple random access occasions corresponding to the defined position, an uplink random access channel message of the set of multiple uplink random access channel messages, the uplink random access channel message including a random access channel preamble, where the defined position within the set of multiple random access occasions corresponds to a sequentially first position of the random access occasion within the set of multiple random access occasions.

In some examples of the method, apparatuses, and non-transitory computer-readable medium described herein, receiving the set of multiple uplink random access channel messages may include operations, features, means, or instructions for receiving, on a random access occasion of the set of multiple random access occasions corresponding to the defined position, an uplink random access channel message of the set of multiple uplink random access channel messages, the uplink random access channel message including a random access channel preamble, where the defined position within the set of multiple random access occasions corresponds to a sequentially last position of the random access occasion within the set of multiple random access occasions.

Some examples of the method, apparatuses, and non-transitory computer-readable medium described herein may further include operations, features, means, or instructions for transmitting an index of a random access occasion at the defined position within the set of multiple random access occasions.

Some examples of the method, apparatuses, and non-transitory computer-readable medium described herein may further include operations, features, means, or instructions for receiving an uplink random access channel message of the set of multiple uplink random access channel messages, where a start of a random access response window may be based on a random access occasion of the set of multiple random access occasions, and where the random access response window may be for transmitting the downlink random access channel message upon receiving the uplink random access channel message of the set of multiple uplink random access channel messages.

Some examples of the method, apparatuses, and non-transitory computer-readable medium described herein may further include operations, features, means, or instructions for identifying that the defined position within the set of multiple random access occasions corresponds to the random access occasion based on determining the start of the random access response window using the random access occasion.

Some examples of the method, apparatuses, and non-transitory computer-readable medium described herein may further include operations, features, means, or instructions for transmitting a control portion of the downlink random access channel message, where the control portion includes a cyclic redundancy check scrambled by the radio network temporary identifier.

In some examples of the method, apparatuses, and non-transitory computer-readable medium described herein, receiving the set of multiple uplink random access channel messages may include operations, features, means, or instructions for receiving, on a first random access occasion of the set of multiple random access occasions corresponding to the defined position, a first uplink random access channel message of the set of multiple uplink random access channel messages and receiving, on a second random access occasion of the set of multiple random access occasions corresponding to the defined position, a second uplink random access channel message of the set of multiple uplink random access channel messages, where the second uplink random access channel message may be received later than the first uplink random access channel message.

Some examples of the method, apparatuses, and non-transitory computer-readable medium described herein may further include operations, features, means, or instructions for identifying that the defined position within the set of multiple random access occasions corresponds to the second random access occasion based on the second uplink random access channel message being received later than the first uplink random access channel message.

### BRIEF DESCRIPTION OF THE DRAWINGS

FIG. 1 illustrates an example of a wireless communications system that supports radio network temporary identifier selection for multiple random access transmissions in accordance with one or more aspects of the present disclosure.

FIG. 2 illustrates an example of a wireless communications system that supports radio network temporary identifier selection for multiple random access transmissions in accordance with one or more aspects of the present disclosure.

FIGS. 3A and 3B illustrate examples of communication timelines that support radio network temporary identifier selection for multiple random access transmissions in accordance with one or more aspects of the present disclosure.

FIGS. 4A and 4B illustrate examples of communication timelines that supports radio network temporary identifier selection for multiple random access transmissions in accordance with one or more aspects of the present disclosure.

FIG. 5 illustrates an example of a process flow that supports radio network temporary identifier selection for multiple random access transmissions in accordance with one or more aspects of the present disclosure.

FIGS. 6 and 7 show block diagrams of devices that support radio network temporary identifier selection for multiple random access transmissions in accordance with one or more aspects of the present disclosure.

FIG. 8 shows a block diagram of a communications manager that supports radio network temporary identifier selection for multiple random access transmissions in accordance with one or more aspects of the present disclosure.

FIG. 9 shows a diagram of a system including a device that supports radio network temporary identifier selection for multiple random access transmissions in accordance with one or more aspects of the present disclosure.

FIGS. 10 and 11 show block diagrams of devices that support radio network temporary identifier selection for multiple random access transmissions in accordance with one or more aspects of the present disclosure.

FIG. 12 shows a block diagram of a communications manager that supports radio network temporary identifier selection for multiple random access transmissions in accordance with one or more aspects of the present disclosure.

FIG. 13 shows a diagram of a system including a device that supports radio network temporary identifier selection for multiple random access transmissions in accordance with one or more aspects of the present disclosure.

FIGS. 14 through 17 show flowcharts illustrating methods that support radio network temporary identifier selection for multiple random access transmissions in accordance with one or more aspects of the present disclosure.

### DETAILED DESCRIPTION

Some wireless systems support establishment of communications between a user equipment (UE) and a network entity using a random access procedure that may enable a UE to synchronize with the network entity. A communication device (e.g., UE) may be configured by a network entity (e.g., base station) through higher level signaling (e.g., control signaling) for random access channel communications. In some cases, a random access procedure may include transmission of a series handshake messages. For example, random access procedures may include four-step handshake messages between a UE and a base station. Such messages may be unscheduled, for example, and may be transmitted on a shared random access channel. In some wireless communications systems, a random access procedure may include transmission of two handshake messages instead of four handshake messages. A random access procedure may include a first transmission (e.g., an uplink message) transmitted by the UE to the base station, followed by a second transmission (e.g., a downlink response) transmitted by the base station responsive to the first transmission. In some examples, the uplink message may include a preamble. Additionally or alternatively, the uplink message may include a preamble and data. In some cases, the UE may transmit the uplink message on a set of multiple random access occasions in order to improve coverage. The UE may receive the downlink transmission based on receiving a control signal scrambled based on a radio network temporary identifier.

Techniques depicted herein provide for a communication device to select a random access occasion from a set of random access occasions when calculating a radio network temporary identifier. When the UE and the network entity uses multiple random access occasions for communicating, the UE and the network entity may utilize the techniques depicted herein to synchronize over a random access occasion to use in selecting the radio network temporary identifier. In some aspects of the present disclosure, the communication device and network entity may be configured to use a specified random access occasion of a set of random access occasions when selecting a radio network temporary identifier. The communication device and the network entity may select a radio network temporary identifier based on a defined position within the set of random access occasions. For example, the network entity and communication device may be configured to use a first or last random access occasion used by the communication device to transmit a random access preamble. In other examples, the network entity may configure the communication device with the index of the random access occasion to use in selecting the radio network temporary identifier. A random access occasion may be identified by an index associated with the first orthogonal frequency division multiplexing symbol of the random access occasion. The network entity may indicate the index to the communication device through control signaling or as system information. Alternatively, in some other implementations the communication device and the network entity may be configured to select the radio network temporary identifier based on the random access occasion that is used to determine the beginning of the random access response window.

Particular implementations of the subject matter described in this disclosure can be implemented to realize one or more of the following potential advantages. The described techniques may support improvements in resource usage (e.g., time and frequency resources) for random access messages, among other advantages. As such, supported techniques may also support enhanced network coverage and improved reliability for random access messaging.

Aspects of the disclosure are initially described in the context of wireless communications systems. Aspects of the disclosure are further described in the context of communication timelines and process flow. Aspects of the disclosure are further illustrated by and described with reference to apparatus diagrams, system diagrams, and flowcharts that relate to radio network temporary identifier selection for multiple random access transmissions.

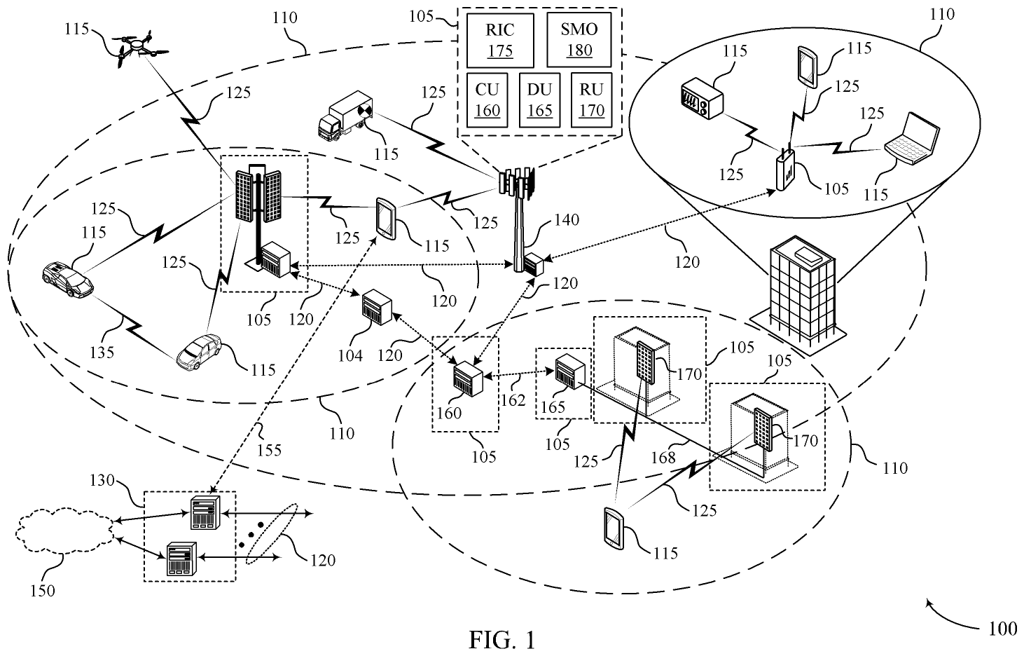

FIG. 1 illustrates an example of a wireless communications system 100 that supports radio network temporary identifier selection for multiple random access transmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support radio network temporary identifier selection for multiple random access transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), etc., and NB-IoT may include eNB-IoT (enhanced NB-IoT), and FeNB-IoT (further enhanced NB-IoT).

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In wireless communications systems, a UE 115 and a network entity 105 may engage in a Type-1 random access procedure or a Type-2 random access procedure. In particular, wireless devices operating in a wireless network (e.g., an NR network) may participate in a two-step random access procedure to reduce delay compared to a four-step random access procedure. In some cases, the two-step random access procedure may operate regardless of whether a wireless device (e.g., a UE 115) has a valid timing advance. Additionally, the two-step random access procedure may be applicable to any cell size, may apply to both contention-based and contention-free random access procedures, and may combine multiple random access messages from a four-step random access procedure.

For example, a UE 115 may select a random access occasion (e.g., from designated random access resources, such as a physical random access occasion) to send a random access request (e.g., message A (msgA) in two-step random access) to a network entity 105. In some cases, msgA may include a random access preamble selected by the UE 115 (e.g., from a set of preambles) and a payload with data contents. In some cases, the UE 115 may transmit this payload on a random access physical uplink shared channel configured by the network entity for msgA payloads. As such, random access msgA may combine the contents of a random access message 1 and random access message 3 from four-step random access procedure. In some cases, the network entity 105 may transmit a random access response (e.g., message B or random access msgB) to the UE 115. In some examples, the random access msgB may include timing advance information and resource allocation and may combine the equivalent contents of a random access message 2 and a random access message 4 from four-step random access procedure.

In some examples, for Type-1 random access procedure, the network entity 105 may provide the UE 115 with a number N of synchronization signal/physical broadcast channel (SS/PBCH) block indexes associated with one random access preamble occasion. The UE 115 may also identify a number R of contention based preambles per SS/PBCH block index per valid random access preamble occasion by ssb-perRACH-OccasionAndCB-PreamblesPerSSB. For Type-1 random access procedure, or for Type-2 random access procedure with separate configuration of random access preamble occasions from Type-1 random access procedure, if N<1, one SS/PBCH block index may be mapped to 1/N consecutive valid random access preamble occasions and R contention based preambles with consecutive indexes associated with the SS/PBCH block index per valid random access preamble occasion may start from preamble index 0. If N≥1, R contention based preambles with consecutive indexes associated with SS/PBCH block index n, 0≤n≤N−1, per valid random access preamble occasion may start from preamble index n. N_{preamble}^{total}/N, where N_{preamble}^{total} is provided by totalNumberOfRA-Preambles for Type-1 random SS/PBCH block indexes provided by ssb-PositionsInBurst in SIB1 or in ServingCellConfigCommon may be mapped to valid random access preamble occasions in the following order: in increasing order of preamble indexes within a single random access preamble occasion, in increasing order of frequency resource indexes for frequency multiplexed random access preamble occasions, in increasing order of time resource indexes for time multiplexed random access preamble occasions within a random access preamble slot, in increasing order of indexes for random access preamble slots, or a combination thereof.

The UE 115 and the network entity 105 may communicate in accordance with an association period. In some examples, an association period, starting from frame 0, for mapping SS/PBCH block indexes to random access preamble occasions may be the smallest value in the set determined by the random access preamble configuration period such that NSSB SS/PBCH block indexes are mapped at least once to the random access preamble occasions within the association period. In some examples, a UE 115 may obtain N_{Tx}^{SSB} from the value of ssb-PositionsInBurst in SIB1 or in ServingCellConfigCommon. If after an integer number of SS/PBCH block indexes to random access preamble occasions mapping cycles within the association period, there is a set of random access preamble occasions or random access preambles that are not mapped to N_{Tx}^{SSB} SS/PBCH block indexes, then the UE 115 may assume that no SS/PBCH block indexes are mapped to the set of random access preamble occasions or random access preambles. An association pattern period may include one or more association periods and may be determined so that a pattern between random access preamble occasions and SS/PBCH block indexes repeats at most every 160 msec. In some examples, random access preamble occasions not associated with SS/PBCH block indexes after an integer number of association periods, if any, are not used for random access preamble transmissions.

In some wireless communication systems, it may be beneficial to support the use of multiple random access preamble occasions to provide increased network coverage. A communication device, such as a UE 115 may select a random access preamble from a set of available random access preambles to use in selecting a radio network temporary identifier. The UE 115 may then transmit multiple uplink communications over a set of random access preamble occasions. A network entity 105 may also determine the radio network temporary identifier based on one of the random access preambles. The radio network temporary identifier may be or may be included as part of a downlink control identifier and may be used in decoding subsequent downlink transmissions. When multiple random access preambles are available, the UE 115 and network entity 105 may synchronize over which random access preamble to use when calculating the radio network temporary identifier. If the UE 115 and network entity 105 do not use the same random access preamble, they may determine different radio network temporary identifier values and be unable to communicate. Some wireless communications networks may not provide for the UE 115 and network entity 105 to jointly determine which random access occasion of a set to use when selecting a radio network temporary identifier.

According to one or more aspects of the present disclosure, the UE 115 and network entity 105 may use a prespecified random access preamble occasion of a set of random access preamble occasions. For example, the UE 115 may receive an indication of a set of random access occasions from the network entity 105. The UE 115 may transmit a set of uplink random access messages to the network entity 105 over the set of random access occasions. The UE 115 may select a radio network temporary identifier based on a defined position within the set of random access occasions. In some cases, the network entity 105 and UE 115 may be configured to use a first or last random access occasion of a random access preamble. In other implementations, the network entity 105 may configure the UE 115 with the index of the random access occasion to use in selecting the radio network temporary identifier. A random access occasion may be identified by an index associated with the first orthogonal frequency division multiplexing symbol of the random access occasion. The index may be signaled to the UE 115 through control signaling or as system information. Alternatively, in some other implementations the UE 115 and the network entity 105 may be configured to calculate the radio network temporary identifier based on the random access occasion that is used to determine the beginning of the random access response window. In many cases, the configuration for determining a random access occasion may be signaled through control signaling.

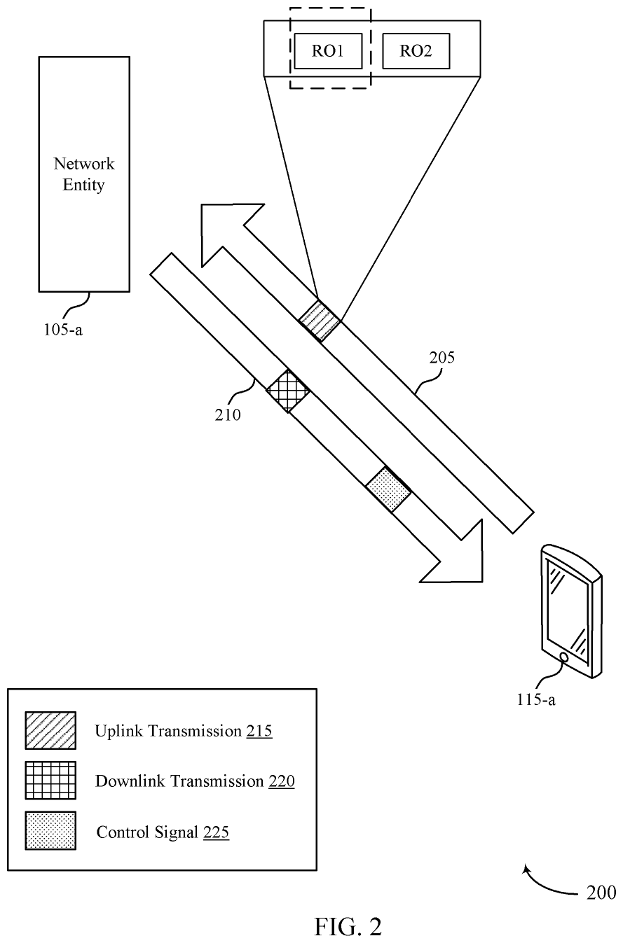

FIG. 2 illustrates an example of a wireless communications system 200 that supports radio network temporary identifier selection for multiple random access transmissions in accordance with one or more aspects of the present disclosure. In particular, the wireless communications system 200 may implement or be implemented to realize aspects of the wireless communications system 100. For example, the wireless communications system 200 may illustrate communication between a UE 115-a and a network entity 105-a, which may be examples of corresponding devices described herein, including with reference to FIG. 1. In some examples, communication between the UE 115-a and the network entity 105-a may be initiated through a random access channel procedure over uplink channel 205 and downlink channel 210. In contention based random access, multiple UEs 115 may share random access occasions, preamble groups, demodulated reference signals, or physical uplink shared channel occasions. This may cause conflict or contention between the UEs 115 when communicating with the network entity 105. In some cases, potential conflicts may be mitigated by having the network entity 105 configure each UE 115 with more than one random access occasions (RO1 and RO2) for uplink transmission.

In some examples, the UE 115-a may synchronize communications with the network entity 105-a by transmitting a random access preamble. The UE 115-a may select a radio network temporary identifier based on a random access occasion. In some examples, the network entity 105-a may select the radio network temporary identifier for the UE 115-a based on one or more parameters associated with the random access preamble. The UE 115-a may detect the scrambled radio network temporary identifier as part of a downlink control indicator in subsequent downlink transmissions. For instance, the UE 115-a may attempt to detect a downlink control indicator (format 1_0) scrambled by a corresponding radio network temporary identifier during a time window. In some examples, the radio network temporary identifier may be based on a random access occasion used by the UE 115-a to transmit a random access channel message.

In many cases, it may be beneficial for the UE 115-a to transmit over multiple random access occasions. In some cases, the multiple random access transmissions may use the same spatial domain filter associated with a synchronization signal block (e.g., strongest synchronization signal block) or channel state information reference signal. In other cases, the multiple random access transmissions may use different spatial domain filters and be associated with different synchronization blocks or channel state information reference signal. Utilizing techniques depicted herein, the UE 115-a and the network entity 105-a may identify a random access occasion being used to select the radio network temporary identifier scrambled in a downlink control message.

As such, the UE 115-a may receive an indication of a set of random access occasions from the network entity 105-a. The UE 115-a may transmit an uplink transmission 215 on an uplink channel 205 over multiple random access occasions (e.g., RO1 and RO2). The UE 115-a may select a radio network temporary identifier based on one random access occasion of the set of random access occasions (e.g., either RO1 or RO2). In some implementations, the UE 115-a may receive a control signal 225 from the network entity 105-a that configures the UE 115-a with a specific random access occasion of the set of random access occasions to use in selecting the radio network temporary identifier. In some instances, the UE 115-a may select a radio network temporary identifier for the UE 115-a based at on a defined position within the set of random access occasions. For example, the UE 115-a may be configured through the control signal 225 to use a random access RO1 in selecting the radio network temporary identifier. In some cases, RO1 may be an example of a first random access occasion transmitted for a respective random access preamble. For instance, the UE 115-a may determine that the defined position within the set of random access occasions corresponds to a sequentially first position of the random access occasion within the set of random access occasions. In other cases, RO1 may be an example of a last random access occasion transmitted for a respective random access preamble. For example, the UE 115-a may determine that the defined position within the set of random access occasions corresponds to a sequentially last position of the random access occasion within the set of random access occasions. Additionally or alternatively, RO1 may be associated with an random access preamble index indicated in the control signal 225. For instance, the UE 115-a may receive an index of a random access occasion at the defined position (corresponding to RO1) within the set of random access occasions. In some cases, RO1 may be an example of the random access preamble occasion that was used in a previous transmission.

The network entity 105-a may receive the uplink transmission 215 over multiple random access occasions RO1 and RO2. The network entity 105-a may calculate the radio network temporary identifier based on the received random access preamble occasion RO1, where RO1 is the position of the random access occasion configured in control signal 225. The network entity 105-a may then transmit a downlink transmission 220 that includes a downlink control indicator including cyclic redundancy check scrambled by the radio network temporary identifier. When the UE 115-a receives the downlink transmission 220, the UE 115-a may decode the transmission and continue communicating with the network entity 105-a.

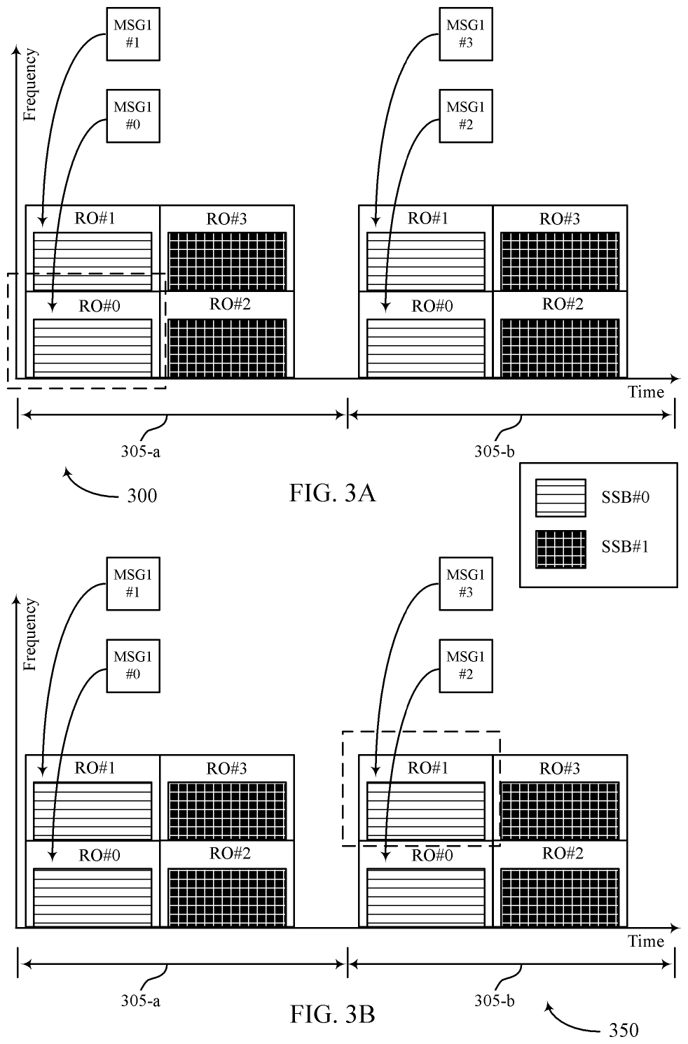

FIGS. 3A and 3B illustrate examples of communication timelines 300 and 350 that support radio network temporary identifier selection for multiple random access transmissions in accordance with one or more aspects of the present disclosure. The UE 115 may be configured to transmit on multiple random access occasions. As shown in FIGS. 3A and 3B, the UE 115 may transmit over multiple association periods 305. Each association period 305 may support multiple random access occasions (RO #0, RO #1, RO #2, and RO #3) for uplink communications. RO #0 and RO #1 may be associated with a first synchronization signal block SSB #0 while RO #2 and RO #3 may be associated with a second synchronization signal block SSB #1. In the example shown in FIG. 3, N_{Tx}^{SSB} may be equal to 2, N may be equal to ½, and MSG1-FDM may be equal to 2, where N_{Tx}^{SSB} is the number of synchronization signal blocks, N is the number of synchronization signal/physical block channel indexes associated with one random access occasion, and MSG1-FDM may be frequency division multiplexing for the uplink transmission. For example, a first message (MSG1) may be an example of MsgA or Msg1 used in a 2-step or 4-step random access procedure. In some cases, MSG1 may include a random access preamble and a payload (e.g., physical uplink shared channel). The UE 115 may choose from the available random access occasions (RO #0, RO #1, RO #2, and RO #3) for transmitting MSG1. In the example shown in FIG. 3A, the UE 115 may transmit MSG1 #0 on the first random access occasion RO #0, of the set of random access occasions. One random access occasion may not be able to support all configured repetitions of MSG1. Therefore, the UE 115 and the network entity 105 may support repetitions across association periods 305. The UE 115 may transmit redundant versions of MSG1 on RO #1 of association period 305-a as well as on RO #1 of the association period 305-b. As shown in FIG. 3A, the UE 115 may be configured to calculate the radio network temporary identifier based on the first random access occasion for a given random access preamble. In other cases, as shown in FIG. 3B, the UE 115 may be configured to calculate the radio network temporary identifier based on the last random occasion preamble for a given random access preamble.

In some implementations, the UE 115 may be configured through control signaling (e.g., RRC or system information) with the index of the random access occasion to use. The MsgB radio network temporary identifier associated with the random access occasion in which the random access preamble is transmitted may be computed as:

$$MsgB - RNTI = 1 + s\_id + 14 * t\_id + 14 * 80 * f\_id + 14 * 80 * 8 * ul\_carrier \_id + 14 * 80 * 8 * 2$$

where s_id is the index of the first OFDM symbol of the random access occasion (0≤s_id<14), t_id is the index of the first slot of the random access occasion in a system frame (0≤t_id<80). In some examples, the subcarrier spacing to determine t_id is based on the value of μ, f_id is the index of the random access occasion in the frequency domain (0≤f_id<8), and ul_carrier_id is the uplink carrier used for random access preamble transmission. In some cases, as shown in FIG. 3A, the received index may correspond to the first random access occasion RO #0 of a given random access preamble. In other cases, as shown in FIG. 3B, the received index may correspond to the last random access occasion RO #1 of a given random access preamble.

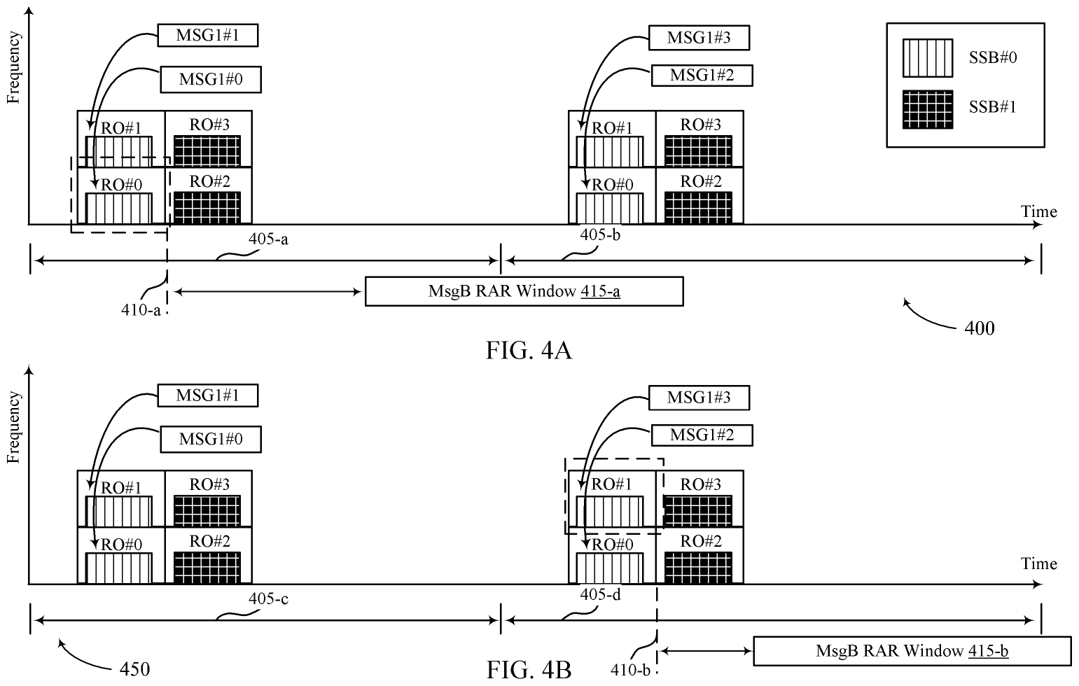

FIGS. 4A and 4B illustrate example of communication timelines 400 and 450 that supports radio network temporary identifier selection for multiple random access transmissions in accordance with one or more aspects of the present disclosure. A UE 115 and a network entity 105 may communicate using multiple random access occasions in accordance with techniques depicted herein. As shown in FIGS. 4A and 4B, the UE 115 may transmit over multiple association periods 405 (e.g., 405-a, 405-b, 405-c, and 405-d).

During a 2-step random access procedure or a 4-step random access procedure, the network entity 105 may transmit a MsgB, which may be an example of MsgB in 2-step random access procedure or Msg2 in 4-step random access procedure, in response to an uplink transmission. The MsgB may include a transmission associated with a radio network temporary identifier selected based on the configured random access occasion and a physical downlink shared channel. The physical downlink shared channel may include an indication (e.g. SuccessRAR or FailureRAR) of whether an initial uplink transmission (Msg1 or MsgA) was received successfully at the network entity 105. The UE 115 may attempt to detect a DCI format 1_0 with cyclic redundancy check scrambled by a corresponding MsgB radio network temporary identifier during a window controlled by high layers. If a FailureRAR is received or if no Msg2 or if no MsgB is received during the window, the UE 115 may attempt to retransmit Msg1 or MsgA.

In some implementations, the UE 115 may be configured to determine the radio network temporary identifier based on the random access occasion used to determine the start of the MsgB RAR window 415. The UE 115 may calculate the start of the MsgB RAR window 415 using a random access occasion as a reference. In some instances, the UE 115 may transmit an uplink random access channel message of a set of uplink random access channel messages, where a start of a random access response window is based on a random access occasion of the set of random access occasions. In some cases, the random access response window is for receiving the downlink random access channel message upon transmitting the uplink random access channel message of the set of uplink random access channel messages. For example, as shown in FIG. 4A, the UE 115 may be configured to use the first random access occasion (RO #0) of the given random access preamble for a transmission, and the start of MsgB RAR Window 415-a may be at an offset from time 410-a. In another example, the UE 115 may be configured to use the last random access occasion (RO #1) of the given random access preamble and the start of MsgB RAR Window 415-b may be at an offset from time 410-b.

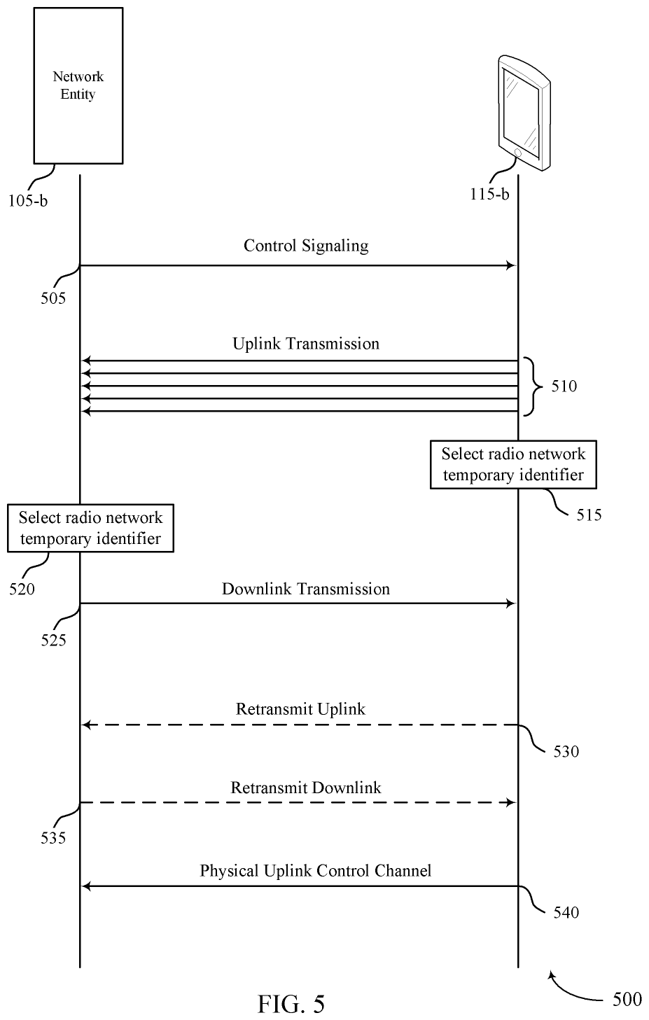

FIG. 5 illustrates an example of a process flow 500 that supports radio network temporary identifier selection for multiple random access transmissions in accordance with one or more aspects of the present disclosure. In some examples, the process flow 500 may implement aspects of wireless communications system 100 and the wireless communications system 200 described with reference to FIGS. 1 and 2, respectively. For example, the process flow 500 may be based on one or more rules for random access procedure in wireless communication systems. The process flow 500 may be implemented by the network entity 105-b and the UE 115-b for synchronization of random access preamble occasions and may enhance network coverage and improve reliability among other benefits. The network entity 105-b and the UE 115-b may be examples of a network entity 105 and UE 115 as described with reference to FIGS. 1 and 2.

In the following description of the process flow 500, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 500, and other operations may be added to the process flow 500.

At 505, the network entity 105-b may configure the UE 115-b through control signaling (e.g., RRC). The control signal may include a set of random access occasions over which the UE 115-b may communicate. The control signal may also include an indication of a defined position within the set of random access occasions to be used to determine a radio network temporary identifier. In some cases, the control signal may configure the UE 115-b with the position of the first random access occasion of a given random access preamble. In other cases, the control signal may configure the UE 115-b with the position of the last random access occasion of a given random access preamble.

In some implementations, the control signal may include an index of a random access occasion at a defined position within the set of random access occasions. In other implementations, the control signal may indicate the random access occasion corresponding to the random access occasion used to determine the start of the random access response window.

At 510, the UE 115-b may transmit a series of uplink transmissions over a set of random access occasions. The uplink transmissions may include a MsgA or Msg1 as well as repetitions of the MsgA or Msg1. At 515, the UE 115-b may select a radio network temporary identifier based on the random access occasion defined by the positioning included in the control signal. The UE 115-b may include the calculated radio network temporary identifier in the random access preamble of the uplink transmissions.

At 520, the network entity 105-b may also select the radio network temporary identifier based on the random access occasion defined by the positioning included in the control signal. At 525, the network entity may transmit a downlink transmission which may include a cyclic redundancy check scrambled by the radio network temporary identifier. The UE 115-b may detect the downlink transmission during a random access response window.

At 530, the UE 115-b may optionally retransmit the uplink transmission if a downlink transmission is not received or the downlink transmission includes a negative acknowledge (e.g., FailureRAR). If the retransmitted uplink signal is successfully received, the network entity 105-b may optionally respond by retransmitting the downlink transmission at 535. At 540, the UE 115-b may transmit an acknowledgement or negative acknowledgement on a physical uplink control channel indicating whether the downlink transmission was successfully received.

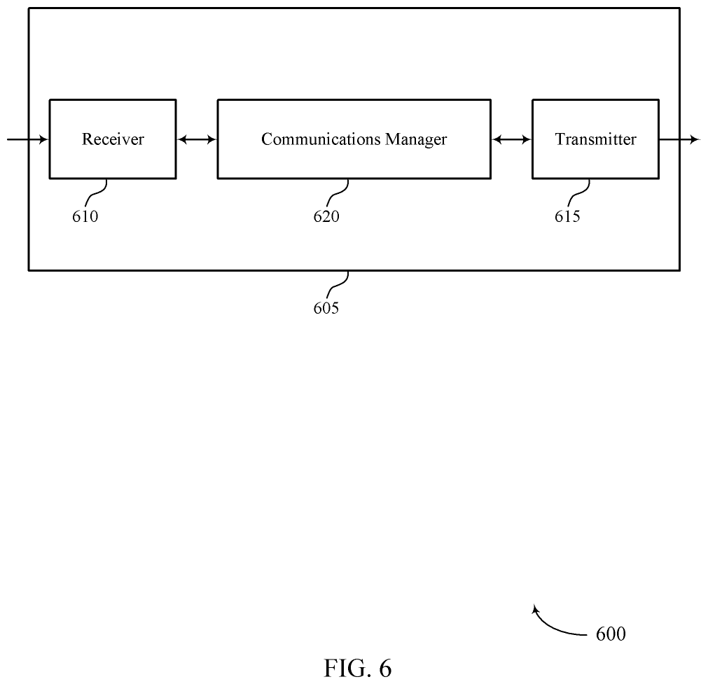

FIG. 6 shows a block diagram 600 of a device 605 that supports radio network temporary identifier selection for multiple random access transmissions in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to radio network temporary identifier selection for multiple random access transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to radio network temporary identifier selection for multiple random access transmissions). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of radio network temporary identifier selection for multiple random access transmissions as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include at least one processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by at least one processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving an indication of a set of multiple random access occasions associated with a random access procedure. The communications manager 620 may be configured as or otherwise support a means for transmitting a set of multiple uplink random access channel messages over the set of multiple random access occasions corresponding to the set of multiple uplink random access channel messages. The communications manager 620 may be configured as or otherwise support a means for selecting a radio network temporary identifier for the UE based on a defined position within the set of multiple random access occasions. The communications manager 620 may be configured as or otherwise support a means for receiving a downlink random access channel message using the radio network temporary identifier based on the defined position within the set of multiple random access occasions.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

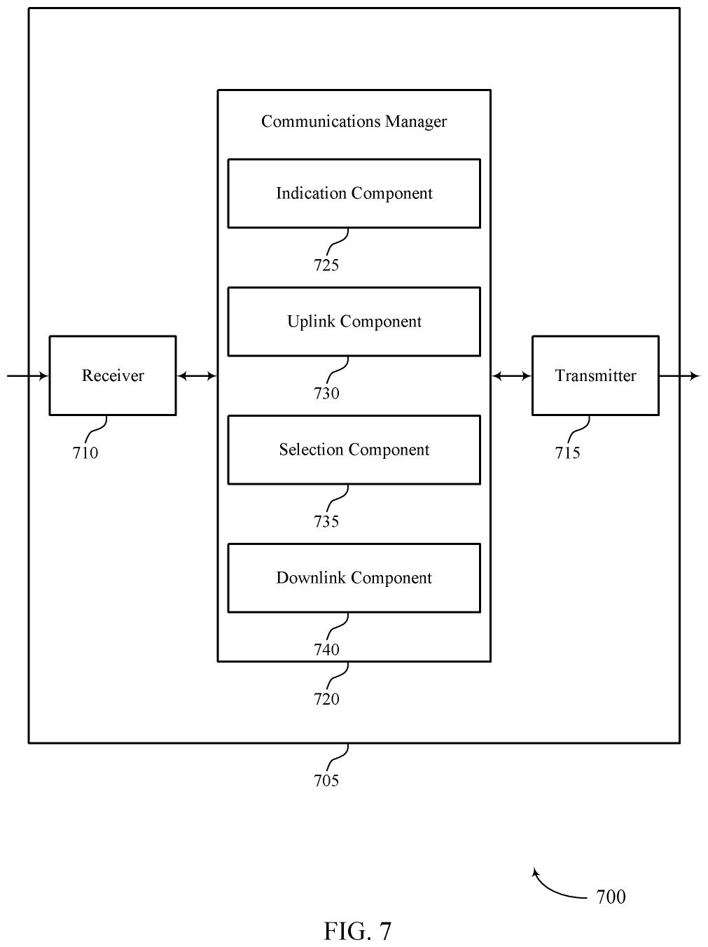

FIG. 7 shows a block diagram 700 of a device 705 that supports radio network temporary identifier selection for multiple random access transmissions in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to radio network temporary identifier selection for multiple random access transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to radio network temporary identifier selection for multiple random access transmissions). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of radio network temporary identifier selection for multiple random access transmissions as described herein. For example, the communications manager 720 may include an indication component 725, an uplink component 730, a selection component 735, a downlink component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The indication component 725 may be configured as or otherwise support a means for receiving an indication of a set of multiple random access occasions associated with a random access procedure. The uplink component 730 may be configured as or otherwise support a means for transmitting a set of multiple uplink random access channel messages over the set of multiple random access occasions corresponding to the set of multiple uplink random access channel messages. The selection component 735 may be configured as or otherwise support a means for selecting a radio network temporary identifier for the UE based on a defined position within the set of multiple random access occasions. The downlink component 740 may be configured as or otherwise support a means for receiving a downlink random access channel message using the radio network temporary identifier based on the defined position within the set of multiple random access occasions.

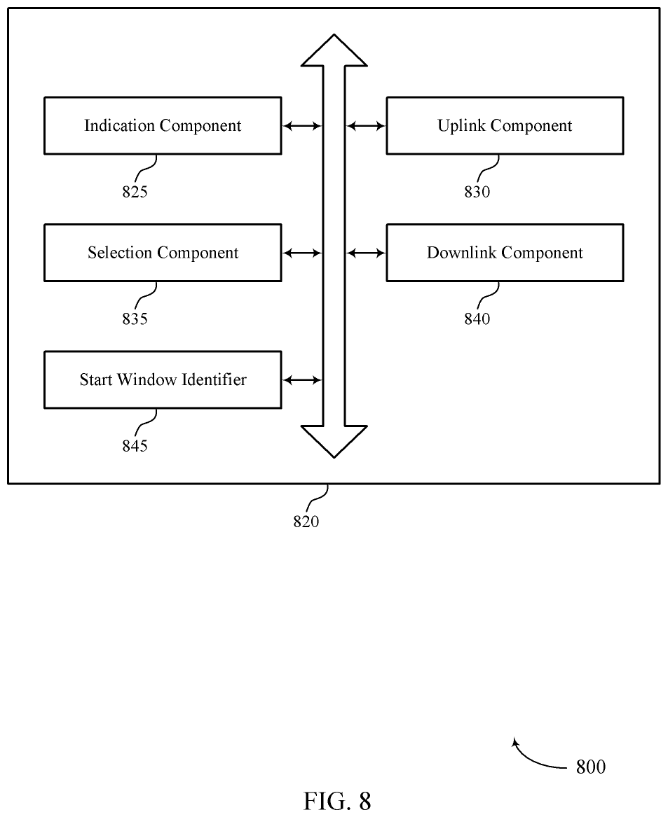

FIG. 8 shows a block diagram 800 of a communications manager 820 that supports radio network temporary identifier selection for multiple random access transmissions in accordance with one or more aspects of the present disclosure. The communications manager 820 may be an example of aspects of a communications manager 620, a communications manager 720, or both, as described herein. The communications manager 820, or various components thereof, may be an example of means for performing various aspects of radio network temporary identifier selection for multiple random access transmissions as described herein. For example, the communications manager 820 may include an indication component 825, an uplink component 830, a selection component 835, a downlink component 840, a start window identifier 845, or any combination thereof. Each of these components may communicate, directly or indirectly, with one another (e.g., via one or more buses).

The communications manager 820 may support wireless communication at a UE in accordance with examples as disclosed herein. The indication component 825 may be configured as or otherwise support a means for receiving an indication of a set of multiple random access occasions associated with a random access procedure. The uplink component 830 may be configured as or otherwise support a means for transmitting a set of multiple uplink random access channel messages over the set of multiple random access occasions corresponding to the set of multiple uplink random access channel messages. The selection component 835 may be configured as or otherwise support a means for selecting a radio network temporary identifier for the UE based on a defined position within the set of multiple random access occasions. The downlink component 840 may be configured as or otherwise support a means for receiving a downlink random access channel message using the radio network temporary identifier based on the defined position within the set of multiple random access occasions.

In some examples, to support transmitting the set of multiple uplink random access channel messages, the uplink component 830 may be configured as or otherwise support a means for transmitting, on a random access occasion of the set of multiple random access occasions corresponding to the defined position, an uplink random access channel message of the set of multiple uplink random access channel messages, the uplink random access channel message including a random access channel preamble, where the defined position within the set of multiple random access occasions corresponds to a sequentially first position of the random access occasion within the set of multiple random access occasions.

In some examples, to support transmitting the set of multiple uplink random access channel messages, the uplink component 830 may be configured as or otherwise support a means for transmitting, on a random access occasion of the set of multiple random access occasions corresponding to the defined position, an uplink random access channel message of the set of multiple uplink random access channel messages, the uplink random access channel message including a random access channel preamble, where the defined position within the set of multiple random access occasions corresponds to a sequentially last position of the random access occasion within the set of multiple random access occasions.

In some examples, the indication component 825 may be configured as or otherwise support a means for receiving an index of a random access occasion at the defined position within the set of multiple random access occasions.

In some examples, the uplink component 830 may be configured as or otherwise support a means for transmitting an uplink random access channel message of the set of multiple uplink random access channel messages, where a start of a random access response window is based on a random access occasion of the set of multiple random access occasions, and where the random access response window is for receiving the downlink random access channel message upon transmitting the uplink random access channel message of the set of multiple uplink random access channel messages.

In some examples, the start window identifier 845 may be configured as or otherwise support a means for identifying that the defined position within the set of multiple random access occasions corresponds to the random access occasion based on determining the start of the random access response window using the random access occasion.

In some examples, the downlink component 840 may be configured as or otherwise support a means for receiving a control portion of the downlink random access channel message, where the control message includes a cyclic redundancy check scrambled by the radio network temporary identifier.

In some examples, to support transmitting the set of multiple uplink random access channel messages, the uplink component 830 may be configured as or otherwise support a means for transmitting, on a first random access occasion of the set of multiple random access occasions corresponding to the defined position, a first uplink random access channel message of the set of multiple uplink random access channel messages. In some examples, to support transmitting the set of multiple uplink random access channel messages, the uplink component 830 may be configured as or otherwise support a means for transmitting, on a second random access occasion of the set of multiple random access occasions corresponding to the defined position, a second uplink random access channel message of the set of multiple uplink random access channel messages, where the second uplink random access channel message is transmitted later than the first uplink random access channel message.

In some examples, the selection component 835 may be configured as or otherwise support a means for identifying that the defined position within the set of multiple random access occasions corresponds to the second random access occasion based on the second uplink random access channel message being transmitted later than the first uplink random access channel message.

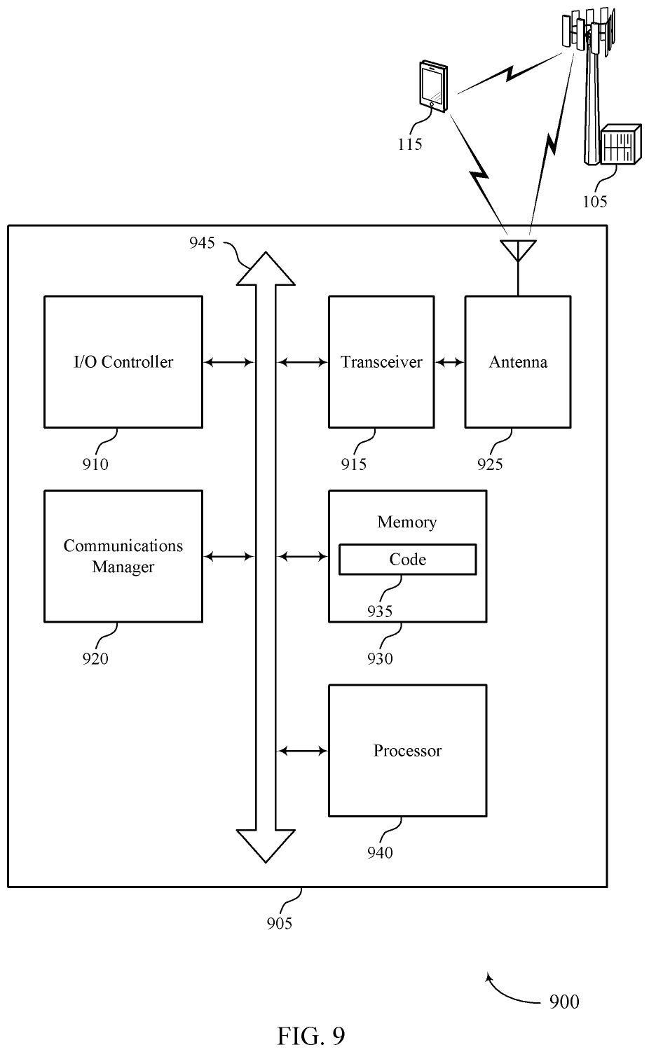

FIG. 9 shows a diagram of a system 900 including a device 905 that supports radio network temporary identifier selection for multiple random access transmissions in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting radio network temporary identifier selection for multiple random access transmissions). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving an indication of a set of multiple random access occasions associated with a random access procedure. The communications manager 920 may be configured as or otherwise support a means for transmitting a set of multiple uplink random access channel messages over the set of multiple random access occasions corresponding to the set of multiple uplink random access channel messages. The communications manager 920 may be configured as or otherwise support a means for selecting a radio network temporary identifier for the UE based on a defined position within the set of multiple random access occasions. The communications manager 920 may be configured as or otherwise support a means for receiving a downlink random access channel message using the radio network temporary identifier based on the defined position within the set of multiple random access occasions.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of radio network temporary identifier selection for multiple random access transmissions as described herein, or the processor 940 and the memory 930 may be otherwise configured to perform or support such operations.

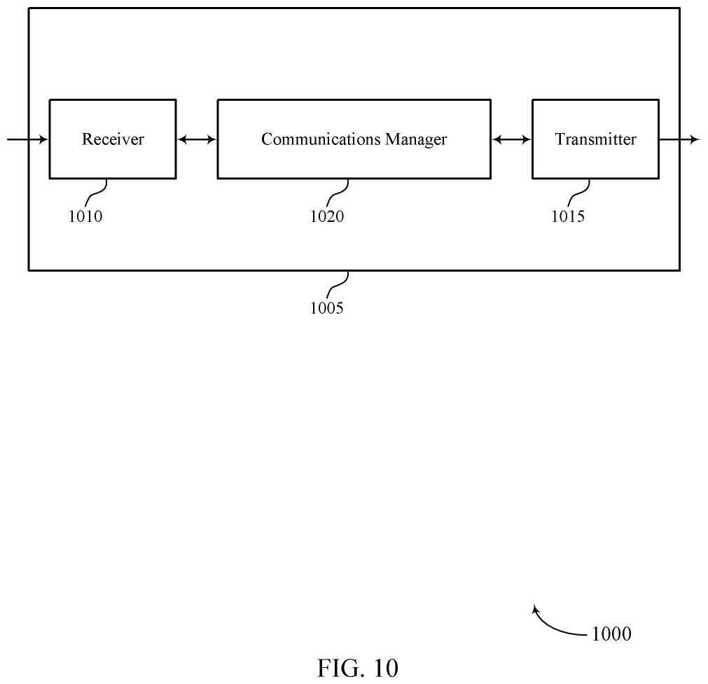

FIG. 10 shows a block diagram 1000 of a device 1005 that supports radio network temporary identifier selection for multiple random access transmissions in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of radio network temporary identifier selection for multiple random access transmissions as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting an indication of a set of multiple random access occasions associated with a random access procedure. The communications manager 1020 may be configured as or otherwise support a means for receiving a set of multiple uplink random access channel messages over a set of multiple random access occasions corresponding to the set of multiple uplink random access channel messages. The communications manager 1020 may be configured as or otherwise support a means for selecting a radio network temporary identifier for a UE based on a defined position within the set of multiple random access occasions. The communications manager 1020 may be configured as or otherwise support a means for transmitting a downlink random access channel message using the radio network temporary identifier based on the defined position within the set of multiple random access occasions.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

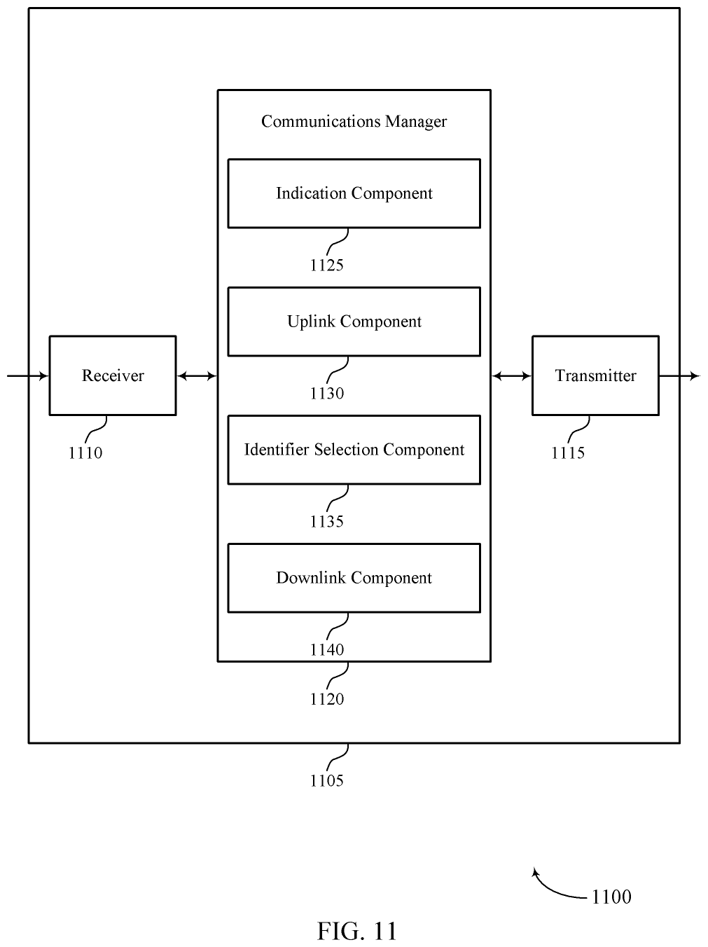

FIG. 11 shows a block diagram 1100 of a device 1105 that supports radio network temporary identifier selection for multiple random access transmissions in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of radio network temporary identifier selection for multiple random access transmissions as described herein. For example, the communications manager 1120 may include an indication component 1125, an uplink component 1130, an identifier selection component 1135, a downlink component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The indication component 1125 may be configured as or otherwise support a means for transmitting an indication of a set of multiple random access occasions associated with a random access procedure. The uplink component 1130 may be configured as or otherwise support a means for receiving a set of multiple uplink random access channel messages over a set of multiple random access occasions corresponding to the set of multiple uplink random access channel messages. The identifier selection component 1135 may be configured as or otherwise support a means for selecting a radio network temporary identifier for a UE based on a defined position within the set of multiple random access occasions. The downlink component 1140 may be configured as or otherwise support a means for transmitting a downlink random access channel message using the radio network temporary identifier based on the defined position within the set of multiple random access occasions.

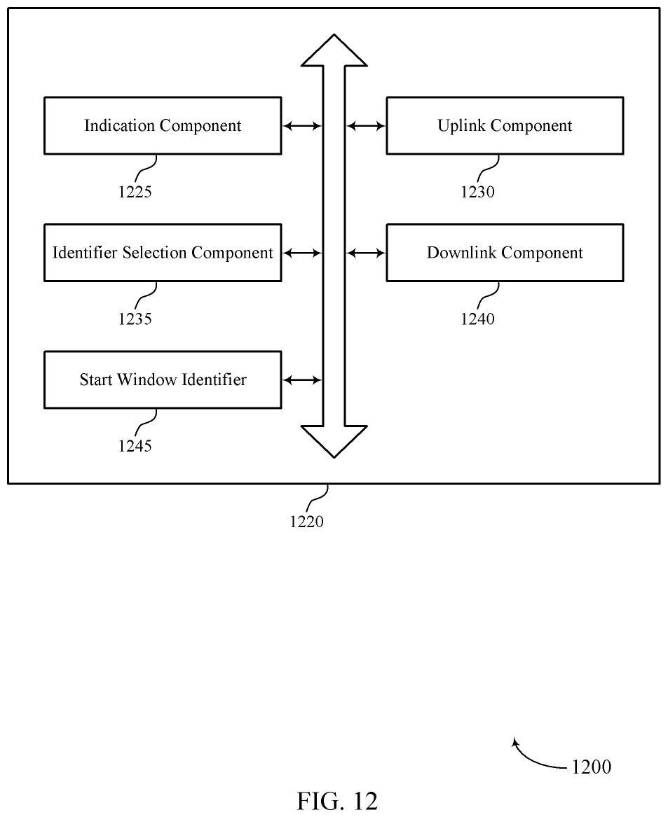

FIG. 12 shows a block diagram 1200 of a communications manager 1220 that supports radio network temporary identifier selection for multiple random access transmissions in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of radio network temporary identifier selection for multiple random access transmissions as described herein. For example, the communications manager 1220 may include an indication component 1225, an uplink component 1230, an identifier selection component 1235, a downlink component 1240, a start window identifier 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The indication component 1225 may be configured as or otherwise support a means for transmitting an indication of a set of multiple random access occasions associated with a random access procedure. The uplink component 1230 may be configured as or otherwise support a means for receiving a set of multiple uplink random access channel messages over a set of multiple random access occasions corresponding to the set of multiple uplink random access channel messages. The identifier selection component 1235 may be configured as or otherwise support a means for selecting a radio network temporary identifier for a UE based on a defined position within the set of multiple random access occasions. The downlink component 1240 may be configured as or otherwise support a means for transmitting a downlink random access channel message using the radio network temporary identifier based on the defined position within the set of multiple random access occasions.

In some examples, to support receiving the set of multiple uplink random access channel messages, the uplink component 1230 may be configured as or otherwise support a means for receiving, on a random access occasion of the set of multiple random access occasions corresponding to the defined position, an uplink random access channel message of the set of multiple uplink random access channel messages, the uplink random access channel message including a random access channel preamble, where the defined position within the set of multiple random access occasions corresponds to a sequentially first position of the random access occasion within the set of multiple random access occasions.

In some examples, to support receiving the set of multiple uplink random access channel messages, the uplink component 1230 may be configured as or otherwise support a means for receiving, on a random access occasion of the set of multiple random access occasions corresponding to the defined position, an uplink random access channel message of the set of multiple uplink random access channel messages, the uplink random access channel message including a random access channel preamble, where the defined position within the set of multiple random access occasions corresponds to a sequentially last position of the random access occasion within the set of multiple random access occasions.

In some examples, the downlink component 1240 may be configured as or otherwise support a means for transmitting an index of a random access occasion at the defined position within the set of multiple random access occasions. In some examples, the uplink component 1230 may be configured as or otherwise support a means for receiving an uplink random access channel message of the set of multiple uplink random access channel messages, where a start of a random access response window is based on a random access occasion of the set of multiple random access occasions, and where the random access response window is for transmitting the downlink random access channel message upon receiving the uplink random access channel message of the set of multiple uplink random access channel messages.

In some examples, the start window identifier 1245 may be configured as or otherwise support a means for identifying that the defined position within the set of multiple random access occasions corresponds to the random access occasion based on determining the start of the random access response window using the random access occasion.

In some examples, the downlink component 1240 may be configured as or otherwise support a means for transmitting a control portion of the downlink random access channel message, where the control portion includes a cyclic redundancy check scrambled by the radio network temporary identifier.

In some examples, to support receiving the set of multiple uplink random access channel messages, the uplink component 1230 may be configured as or otherwise support a means for receiving, on a first random access occasion of the set of multiple random access occasions corresponding to the defined position, a first uplink random access channel message of the set of multiple uplink random access channel messages. In some examples, to support receiving the set of multiple uplink random access channel messages, the uplink component 1230 may be configured as or otherwise support a means for receiving, on a second random access occasion of the set of multiple random access occasions corresponding to the defined position, a second uplink random access channel message of the set of multiple uplink random access channel messages, where the second uplink random access channel message is received later than the first uplink random access channel message.

In some examples, the identifier selection component 1235 may be configured as or otherwise support a means for identifying that the defined position within the set of multiple random access occasions corresponds to the second random access occasion based on the second uplink random access channel message being received later than the first uplink random access channel message.

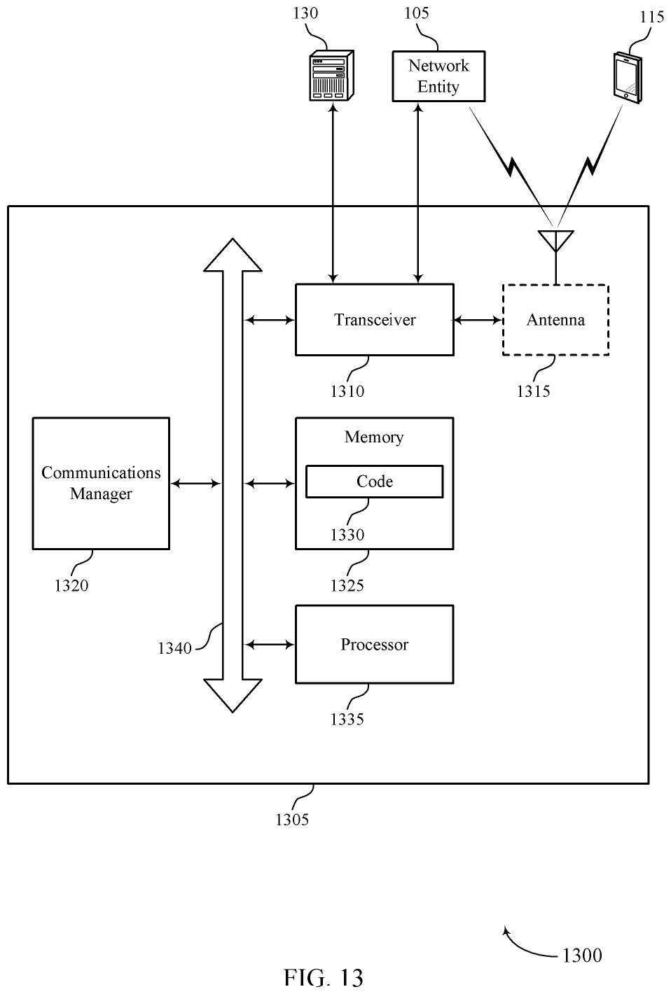

FIG. 13 shows a diagram of a system 1300 including a device 1305 that supports radio network temporary identifier selection for multiple random access transmissions in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting radio network temporary identifier selection for multiple random access transmissions). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting an indication of a set of multiple random access occasions associated with a random access procedure. The communications manager 1320 may be configured as or otherwise support a means for receiving a set of multiple uplink random access channel messages over a set of multiple random access occasions corresponding to the set of multiple uplink random access channel messages. The communications manager 1320 may be configured as or otherwise support a means for selecting a radio network temporary identifier for a UE based on a defined position within the set of multiple random access occasions. The communications manager 1320 may be configured as or otherwise support a means for transmitting a downlink random access channel message using the radio network temporary identifier based on the defined position within the set of multiple random access occasions.

By including or configuring the communications manager 1320 in accordance with examples as described herein, the device 1305 may support techniques for improved communication reliability, reduced latency, improved user experience related to reduced processing, reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of radio network temporary identifier selection for multiple random access transmissions as described herein, or the processor 1335 and the memory 1325 may be otherwise configured to perform or support such operations.

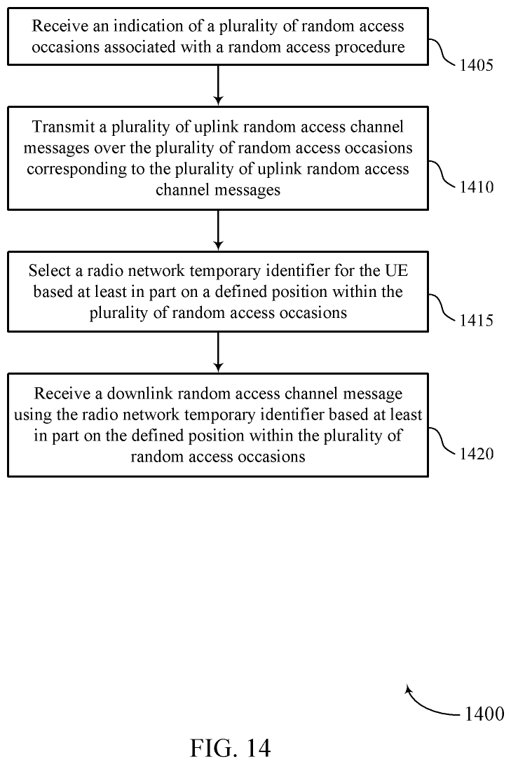

FIG. 14 shows a flowchart illustrating a method 1400 that supports radio network temporary identifier selection for multiple random access transmissions in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a plurality of random access occasions associated with a random access procedure. The operations of 1405 may be performed in accordance with examples as disclosed herein. In some examples, aspects of the operations of 1405 may be performed by an indication component 825 as described with reference to FIG. 8.

At 1410, the method may include transmitting a plurality of uplink random access channel messages over the plurality of random access occasions corresponding to the plurality of uplink random access channel messages. The operations of 1410 may be performed in accordance with examples as disclosed herein. In some examples, aspects of the operations of 1410 may be performed by an uplink component 830 as described with reference to FIG. 8.

At 1415, the method may include selecting a radio network temporary identifier for the UE based at least in part on a defined position within the plurality of random access occasions. The operations of 1415 may be performed in accordance with examples as disclosed herein. In some examples, aspects of the operations of 1415 may be performed by a selection component 835 as described with reference to FIG. 8.

At 1420, the method may include receiving a downlink random access channel message using the radio network temporary identifier based at least in part on the defined position within the plurality of random access occasions. The operations of 1420 may be performed in accordance with examples as disclosed herein. In some examples, aspects of the operations of 1420 may be performed by a downlink component 840 as described with reference to FIG. 8.

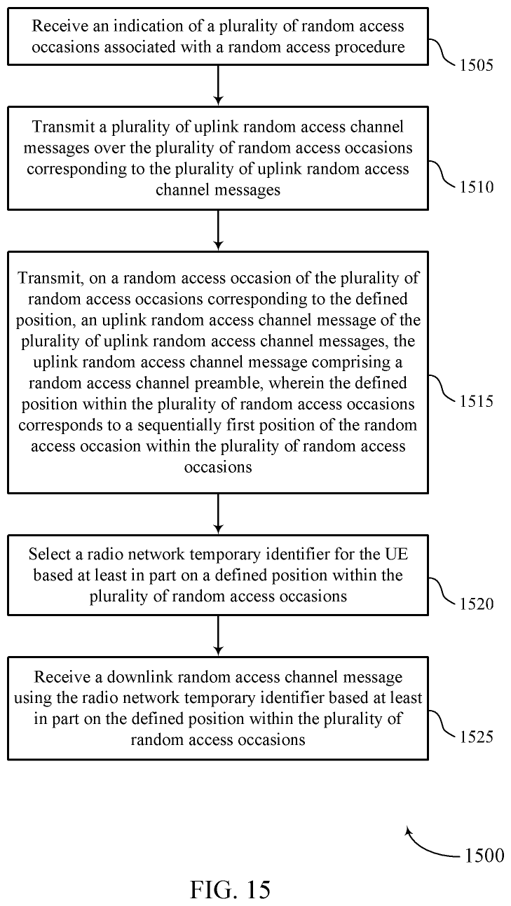

FIG. 15 shows a flowchart illustrating a method 1500 that supports radio network temporary identifier selection for multiple random access transmissions in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a plurality of random access occasions associated with a random access procedure. The operations of 1505 may be performed in accordance with examples as disclosed herein. In some examples, aspects of the operations of 1505 may be performed by an indication component 825 as described with reference to FIG. 8.

At 1510, the method may include transmitting a plurality of uplink random access channel messages over the plurality of random access occasions corresponding to the plurality of uplink random access channel messages. The operations of 1510 may be performed in accordance with examples as disclosed herein. In some examples, aspects of the operations of 1510 may be performed by an uplink component 830 as described with reference to FIG. 8.

At 1515, the method may include transmitting, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially first position of the random access occasion within the plurality of random access occasions. The operations of 1515 may be performed in accordance with examples as disclosed herein. In some examples, aspects of the operations of 1515 may be performed by an uplink component 830 as described with reference to FIG. 8.

At 1520, the method may include selecting a radio network temporary identifier for the UE based at least in part on a defined position within the plurality of random access occasions. The operations of 1520 may be performed in accordance with examples as disclosed herein. In some examples, aspects of the operations of 1520 may be performed by a selection component 835 as described with reference to FIG. 8.

At 1525, the method may include receiving a downlink random access channel message using the radio network temporary identifier based at least in part on the defined position within the plurality of random access occasions. The operations of 1525 may be performed in accordance with examples as disclosed herein. In some examples, aspects of the operations of 1525 may be performed by a downlink component 840 as described with reference to FIG. 8.

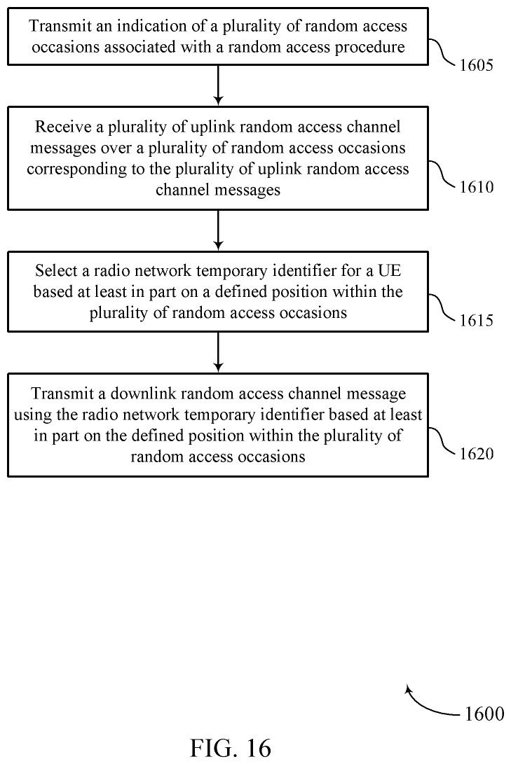

FIG. 16 shows a flowchart illustrating a method 1600 that supports radio network temporary identifier selection for multiple random access transmissions in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting an indication of a plurality of random access occasions associated with a random access procedure. The operations of 1605 may be performed in accordance with examples as disclosed herein. In some examples, aspects of the operations of 1605 may be performed by an indication component 1225 as described with reference to FIG. 12.

At 1610, the method may include receiving a plurality of uplink random access channel messages over a plurality of random access occasions corresponding to the plurality of uplink random access channel messages. The operations of 1610 may be performed in accordance with examples as disclosed herein. In some examples, aspects of the operations of 1610 may be performed by an uplink component 1230 as described with reference to FIG. 12.

At 1615, the method may include selecting a radio network temporary identifier for a UE based at least in part on a defined position within the plurality of random access occasions. The operations of 1615 may be performed in accordance with examples as disclosed herein. In some examples, aspects of the operations of 1615 may be performed by an identifier selection component 1235 as described with reference to FIG. 12.

At 1620, the method may include transmitting a downlink random access channel message using the radio network temporary identifier based at least in part on the defined position within the plurality of random access occasions. The operations of 1620 may be performed in accordance with examples as disclosed herein. In some examples, aspects of the operations of 1620 may be performed by a downlink component 1240 as described with reference to FIG. 12.

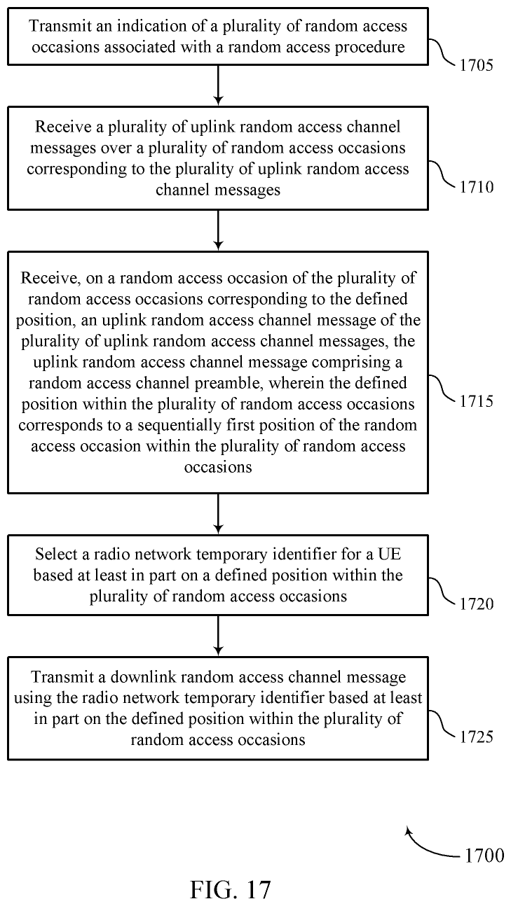

FIG. 17 shows a flowchart illustrating a method 1700 that supports radio network temporary identifier selection for multiple random access transmissions in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting an indication of a plurality of random access occasions associated with a random access procedure. The operations of 1705 may be performed in accordance with examples as disclosed herein. In some examples, aspects of the operations of 1705 may be performed by an indication component 1225 as described with reference to FIG. 12.

At 1710, the method may include receiving a plurality of uplink random access channel messages over a plurality of random access occasions corresponding to the plurality of uplink random access channel messages. The operations of 1710 may be performed in accordance with examples as disclosed herein. In some examples, aspects of the operations of 1710 may be performed by an uplink component 1230 as described with reference to FIG. 12.

At 1715, the method may include receiving, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially first position of the random access occasion within the plurality of random access occasions. The operations of 1715 may be performed in accordance with examples as disclosed herein. In some examples, aspects of the operations of 1715 may be performed by an uplink component 1230 as described with reference to FIG. 12.

At 1720, the method may include selecting a radio network temporary identifier for a UE based at least in part on a defined position within the plurality of random access occasions. The operations of 1720 may be performed in accordance with examples as disclosed herein. In some examples, aspects of the operations of 1720 may be performed by an identifier selection component 1235 as described with reference to FIG. 12.

At 1725, the method may include transmitting a downlink random access channel message using the radio network temporary identifier based at least in part on the defined position within the plurality of random access occasions. The operations of 1725 may be performed in accordance with examples as disclosed herein. In some examples, aspects of the operations of 1725 may be performed by a downlink component 1240 as described with reference to FIG. 12.

The following provides an overview of aspects of the present disclosure:
Aspect 1: A method for wireless communication at a UE, comprising: receiving an indication of a plurality of random access occasions associated with a random access procedure; transmitting a plurality of uplink random access channel messages over the plurality of random access occasions corresponding to the plurality of uplink random access channel messages; selecting a radio network temporary identifier for the UE based at least in part on a defined position within the plurality of random access occasions; and receiving a downlink random access channel message using the radio network temporary identifier based at least in part on the defined position within the plurality of random access occasions.
Aspect 2: The method of aspect 1, wherein transmitting the plurality of uplink random access channel messages comprises: transmitting, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially first position of the random access occasion within the plurality of random access occasions.
Aspect 3: The method of any of aspects 1 through 2, wherein transmitting the plurality of uplink random access channel messages comprises: transmitting, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially last position of the random access occasion within the plurality of random access occasions.
Aspect 4: The method of any of aspects 1 through 3, further comprising: receiving an index of a random access occasion at the defined position within the plurality of random access occasions.
Aspect 5: The method of any of aspects 1 through 4, further comprising: transmitting an uplink random access channel message of the plurality of uplink random access channel messages, wherein a start of a random access response window is based at least in part on a random access occasion of the plurality of random access occasions, and wherein the random access response window is for receiving the downlink random access channel message upon transmitting the uplink random access channel message of the plurality of uplink random access channel messages.
Aspect 6: The method of aspect 5, further comprising: identifying that the defined position within the plurality of random access occasions corresponds to the random access occasion based at least in part on determining the start of the random access response window using the random access occasion.
Aspect 7: The method of any of aspects 1 through 6, further comprising: receiving a control portion of the downlink random access channel message, wherein the control message comprises a cyclic redundancy check scrambled by the radio network temporary identifier.
Aspect 8: The method of any of aspects 1 through 7, wherein transmitting the plurality of uplink random access channel messages comprises: transmitting, on a first random access occasion of the plurality of random access occasions corresponding to the defined position, a first uplink random access channel message of the plurality of uplink random access channel messages; and transmitting, on a second random access occasion of the plurality of random access occasions corresponding to the defined position, a second uplink random access channel message of the plurality of uplink random access channel messages, wherein the second uplink random access channel message is transmitted later than the first uplink random access channel message.
Aspect 9: The method of aspect 8, further comprising: identifying that the defined position within the plurality of random access occasions corresponds to the second random access occasion based at least in part on the second uplink random access channel message being transmitted later than the first uplink random access channel message.
Aspect 10: A method for wireless communication at a network entity, comprising: transmitting an indication of a plurality of random access occasions associated with a random access procedure; receiving a plurality of uplink random access channel messages over a plurality of random access occasions corresponding to the plurality of uplink random access channel messages; selecting a radio network temporary identifier for a UE based at least in part on a defined position within the plurality of random access occasions; and transmitting a downlink random access channel message using the radio network temporary identifier based at least in part on the defined position within the plurality of random access occasions.
Aspect 11: The method of aspect 10, wherein receiving the plurality of uplink random access channel messages comprises: receiving, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially first position of the random access occasion within the plurality of random access occasions.
Aspect 12: The method of any of aspects 10 through 11, wherein receiving the plurality of uplink random access channel messages comprises: receiving, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially last position of the random access occasion within the plurality of random access occasions.
Aspect 13: The method of any of aspects 10 through 12, further comprising: transmitting an index of a random access occasion at the defined position within the plurality of random access occasions.
Aspect 14: The method of any of aspects 10 through 13, further comprising: receiving an uplink random access channel message of the plurality of uplink random access channel messages, wherein a start of a random access response window is based at least in part on a random access occasion of the plurality of random access occasions, and wherein the random access response window is for transmitting the downlink random access channel message upon receiving the uplink random access channel message of the plurality of uplink random access channel messages.
Aspect 15: The method of aspect 14, further comprising: identifying that the defined position within the plurality of random access occasions corresponds to the random access occasion based at least in part on determining the start of the random access response window using the random access occasion.
Aspect 16: The method of any of aspects 10 through 15, further comprising: transmitting a control portion of the downlink random access channel message, wherein the control portion comprises a cyclic redundancy check scrambled by the radio network temporary identifier.
Aspect 17: The method of any of aspects 10 through 16, wherein receiving the plurality of uplink random access channel messages comprises: receiving, on a first random access occasion of the plurality of random access occasions corresponding to the defined position, a first uplink random access channel message of the plurality of uplink random access channel messages; and receiving, on a second random access occasion of the plurality of random access occasions corresponding to the defined position, a second uplink random access channel message of the plurality of uplink random access channel messages, wherein the second uplink random access channel message is received later than the first uplink random access channel message.
Aspect 18: The method of aspect 17, further comprising: identifying that the defined position within the plurality of random access occasions corresponds to the second random access occasion based at least in part on the second uplink random access channel message being received later than the first uplink random access channel message.
Aspect 19: An apparatus for wireless communication at a UE, comprising at least one processor; and memory coupled to the at least one processor, the memory storing instructions executable by the at least one processor to cause the UE to perform a method of any of aspects 1 through 9.
Aspect 20: An apparatus for wireless communication at a UE, comprising at least one means for performing a method of any of aspects 1 through 9.
Aspect 21: A non-transitory computer-readable medium storing code for wireless communication at a UE, the code comprising instructions executable by the at least one processor to perform a method of any of aspects 1 through 9.
Aspect 22: An apparatus for wireless communication at a network entity, comprising at least one processor; and memory coupled to the at least one processor, the memory storing instructions executable by the at least one processor to cause the network entity to perform a method of any of aspects 10 through 18.
Aspect 23: An apparatus for wireless communication at a network entity, comprising at least one means for performing a method of any of aspects 10 through 18.
Aspect 24: A non-transitory computer-readable medium storing code for wireless communication at a network entity, the code comprising instructions executable by at least one processor to perform a method of any of aspects 10 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, etc., whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled to the at least one processor, the memory storing instructions executable by the at least one processor to cause the UE to:
receive an indication of a plurality of random access occasions associated with a random access procedure;
transmit a plurality of uplink random access channel messages over the plurality of random access occasions corresponding to the plurality of uplink random access channel messages;
select a radio network temporary identifier for the UE based at least in part on a defined position within the plurality of random access occasions; and
receive a downlink random access channel message using the radio network temporary identifier based at least in part on the defined position within the plurality of random access occasions.

2. The apparatus of claim 1, wherein the instructions to transmit the plurality of uplink random access channel messages are executable by the at least one processor to cause the UE to:
transmit, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially first position of the random access occasion within the plurality of random access occasions.

3. The apparatus of claim 1, wherein the instructions to transmit the plurality of uplink random access channel messages are executable by the at least one processor to cause the UE to:
transmit, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially last position of the random access occasion within the plurality of random access occasions.

4. The apparatus of claim 1, wherein the instructions are further executable by the at least one processor to cause the UE to:
receive an index of a random access occasion at the defined position within the plurality of random access occasions.

5. The apparatus of claim 1, wherein the instructions are further executable by the at least one processor to cause the UE to:
transmit an uplink random access channel message of the plurality of uplink random access channel messages, wherein a start of a random access response window is based at least in part on a random access occasion of the plurality of random access occasions, and wherein the random access response window is for receiving the downlink random access channel message upon transmitting the uplink random access channel message of the plurality of uplink random access channel messages.

6. The apparatus of claim 5, wherein the instructions are further executable by the at least one processor to cause the UE to:
identify that the defined position within the plurality of random access occasions corresponds to the random access occasion based at least in part on determining the start of the random access response window using the random access occasion.

7. The apparatus of claim 1, wherein the instructions are further executable by the at least one processor to cause the UE to:
receive a control portion of the downlink random access channel message, wherein the control message comprises a cyclic redundancy check scrambled by the radio network temporary identifier.

8. The apparatus of claim 1, wherein the instructions to transmit the plurality of uplink random access channel messages are executable by the at least one processor to cause the UE to:
transmit, on a first random access occasion of the plurality of random access occasions corresponding to the defined position, a first uplink random access channel message of the plurality of uplink random access channel messages; and
transmit, on a second random access occasion of the plurality of random access occasions corresponding to the defined position, a second uplink random access channel message of the plurality of uplink random access channel messages, wherein the second uplink random access channel message is transmitted later than the first uplink random access channel message.

9. The apparatus of claim 8, wherein the instructions are further executable by the at least one processor to cause the UE to:
identify that the defined position within the plurality of random access occasions corresponds to the second random access occasion based at least in part on the second uplink random access channel message being transmitted later than the first uplink random access channel message.

10. An apparatus for wireless communication at a network entity, comprising:
at least one processor; and
memory coupled to the at least one processor, the memory storing instructions executable by the at least one processor to cause the network entity to:
transmit an indication of a plurality of random access occasions associated with a random access procedure;
receive a plurality of uplink random access channel messages over a plurality of random access occasions corresponding to the plurality of uplink random access channel messages;
select a radio network temporary identifier for a user equipment (UE) based at least in part on a defined position within the plurality of random access occasions; and
transmit a downlink random access channel message using the radio network temporary identifier based at least in part on the defined position within the plurality of random access occasions.

11. The apparatus of claim 10, wherein the instructions to receive the plurality of uplink random access channel messages are executable by the at least one processor to cause the network entity to:
receive, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially first position of the random access occasion within the plurality of random access occasions.

12. The apparatus of claim 10, wherein the instructions to receive the plurality of uplink random access channel messages are executable by the at least one processor to cause the network entity to:
receive, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially last position of the random access occasion within the plurality of random access occasions.

13. The apparatus of claim 10, wherein the instructions are further executable by the at least one processor to cause the network entity to:
transmit an index of a random access occasion at the defined position within the plurality of random access occasions.

14. The apparatus of claim 10, wherein the instructions are further executable by the at least one processor to cause the network entity to:
receive an uplink random access channel message of the plurality of uplink random access channel messages, wherein a start of a random access response window is based at least in part on a random access occasion of the plurality of random access occasions, and wherein the random access response window is for transmitting the downlink random access channel message upon receiving the uplink random access channel message of the plurality of uplink random access channel messages.

15. The apparatus of claim 14, wherein the instructions are further executable by the at least one processor to cause the network entity to:
identify that the defined position within the plurality of random access occasions corresponds to the random access occasion based at least in part on determining the start of the random access response window using the random access occasion.

16. The apparatus of claim 10, wherein the instructions are further executable by the at least one processor to cause the network entity to:
transmit a control portion of the downlink random access channel message, wherein the control portion comprises a cyclic redundancy check scrambled by the radio network temporary identifier.

17. The apparatus of claim 10, wherein the instructions to receive the plurality of uplink random access channel messages are executable by the at least one processor to cause the network entity to:
receive, on a first random access occasion of the plurality of random access occasions corresponding to the defined position, a first uplink random access channel message of the plurality of uplink random access channel messages; and
receive, on a second random access occasion of the plurality of random access occasions corresponding to the defined position, a second uplink random access channel message of the plurality of uplink random access channel messages, wherein the second uplink random access channel message is received later than the first uplink random access channel message.

18. The apparatus of claim 17, wherein the instructions are further executable by the at least one processor to cause the network entity to:
identify that the defined position within the plurality of random access occasions corresponds to the second random access occasion based at least in part on the second uplink random access channel message being received later than the first uplink random access channel message.

19. A method for wireless communication at a user equipment (UE), comprising:
receiving an indication of a plurality of random access occasions associated with a random access procedure;
transmitting a plurality of uplink random access channel messages over the plurality of random access occasions corresponding to the plurality of uplink random access channel messages;
selecting a radio network temporary identifier for the UE based at least in part on a defined position within the plurality of random access occasions; and
receiving a downlink random access channel message using the radio network temporary identifier based at least in part on the defined position within the plurality of random access occasions.

20. The method of claim 19, wherein transmitting the plurality of uplink random access channel messages comprises:
transmitting, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially first position of the random access occasion within the plurality of random access occasions.

21. The method of claim 19, wherein transmitting the plurality of uplink random access channel messages comprises:
transmitting, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially last position of the random access occasion within the plurality of random access occasions.

22. The method of claim 19, further comprising:
receiving an index of a random access occasion at the defined position within the plurality of random access occasions.

23. The method of claim 19, further comprising:
transmitting an uplink random access channel message of the plurality of uplink random access channel messages, wherein a start of a random access response window is based at least in part on a random access occasion of the plurality of random access occasions, and wherein the random access response window is for receiving the downlink random access channel message upon transmitting the uplink random access channel message of the plurality of uplink random access channel messages.

24. The method of claim 23, further comprising:
identifying that the defined position within the plurality of random access occasions corresponds to the random access occasion based at least in part on determining the start of the random access response window using the random access occasion.

25. The method of claim 19, further comprising:
receiving a control portion of the downlink random access channel message, wherein the control message comprises a cyclic redundancy check scrambled by the radio network temporary identifier.

26. The method of claim 19, wherein transmitting the plurality of uplink random access channel messages comprises:
transmitting, on a first random access occasion of the plurality of random access occasions corresponding to the defined position, a first uplink random access channel message of the plurality of uplink random access channel messages; and
transmitting, on a second random access occasion of the plurality of random access occasions corresponding to the defined position, a second uplink random access channel message of the plurality of uplink random access channel messages, wherein the second uplink random access channel message is transmitted later than the first uplink random access channel message.

27. The method of claim 26, further comprising:
identifying that the defined position within the plurality of random access occasions corresponds to the second random access occasion based at least in part on the second uplink random access channel message being transmitted later than the first uplink random access channel message.

28. A method for wireless communication at a network entity, comprising:
transmitting an indication of a plurality of random access occasions associated with a random access procedure;
receiving a plurality of uplink random access channel messages over a plurality of random access occasions corresponding to the plurality of uplink random access channel messages;
selecting a radio network temporary identifier for a user equipment (UE) based at least in part on a defined position within the plurality of random access occasions; and
transmitting a downlink random access channel message using the radio network temporary identifier based at least in part on the defined position within the plurality of random access occasions.

29. The method of claim 28, wherein receiving the plurality of uplink random access channel messages comprises:
receiving, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially first position of the random access occasion within the plurality of random access occasions.

30. The method of claim 28, wherein receiving the plurality of uplink random access channel messages comprises:
receiving, on a random access occasion of the plurality of random access occasions corresponding to the defined position, an uplink random access channel message of the plurality of uplink random access channel messages, the uplink random access channel message comprising a random access channel preamble, wherein the defined position within the plurality of random access occasions corresponds to a sequentially last position of the random access occasion within the plurality of random access occasions.
